(19) United States
(12) Patent Application Publication
(10) Pub. No.: US 2018/0225720 A1
(43) Pub. Date: Aug. 9, 2018

(54) SYSTEMS AND METHODS FOR USING SOCIAL MEDIA DATA PATTERNS TO GENERATE TIME-BOUND PREDICTIONS

(71) Applicant: MasterCard International Incorporated, Purchase, NY (US)

(72) Inventor: Vijendra Pratap Singh, Pune (IN)

(21) Appl. No.: 15/425,995

(22) Filed: Feb. 6, 2017

(51) Int. Cl. G06Q 30/02; G06Q 50/00

(52) U.S. Cl. CPC G06Q 30/0271; G06Q 30/0276; G06Q 50/01

(57) ABSTRACT

Embodiments of the disclosure enable a system to generate one or more time-bound predictions. The system retrieves one or more social media feeds associated with one or more users, extracts a plurality of terms from a first post included in the social media feeds, analyzes the plurality of terms to determine whether the first post is associated with a potential financial transaction, uses the plurality of terms to generate target information associated with the potential financial transaction, and transmits the target information to one or more promotion systems such that the one or more promotion systems are configured to use the target information to generate one or more promotions associated with a first user associated with the first post. Aspects of the disclosure provide for generating target information in an efficient and user-friendly manner.

### FIELD OF THE DISCLOSURE

The subject matter described herein relates generally to information processing and, more specifically, to systems and methods for using social media data patterns to generate one or more time-bound predictions.

### BACKGROUND

Merchants use promotions to encourage their customers to purchase goods and/or services. Promotions may be generated, for example, based on general industry data and/or conventional knowledge. Such promotions, however, are typically directed to a middle range of the general public and, thus, may not be relevant to at least some customers. To generate promotions targeted to one or more customers, some merchants may generate or identify customer data associated with the customers. Using known promotion systems and methods to generate or identify customer data, however, may be overwhelming, tedious, and/or limited with the volume of data and/or the variety of data sources from which such data may be obtained. Customer data generated using known customer loyalty programs, for example, is typically limited to the customers' spend at the merchant and, if the customers do not consistently present the customer loyalty cards with each interaction, may not be representative of the customers' interests, preferences, and/or tendencies.

### SUMMARY

Embodiments of the disclosure enable a computing system to generate one or more time-bound predictions. The computing system includes a memory device storing data associated with one or more user accounts and computer-executable instructions, and a processor. The processor executes the computer-executable instructions to retrieve one or more social media feeds associated with one or more users, extract a plurality of terms from a first post included in the social media feeds, analyze the plurality of terms to determine whether the first post is associated with a potential financial transaction, use the plurality of terms to generate target information associated with the potential financial transaction, and transmit the target information to one or more promotion systems such that the one or more promotion systems are configured to use the target information to generate one or more promotions associated with a first user that is associated with the first post.

In another aspect, one or more computer storage media embodied with computer-executable instructions are provided. The one or more computer storage media include a feed component, an extraction component, and a target component. Upon execution by at least one processor, the feed component causes a computing system associated with the at least one processor to retrieve a social media feed including one or more posts associated with one or more users, the extraction component causes the computing system to extract a plurality of terms from the one or more posts, and determine whether the plurality of terms include product data, temporal data, and/or location data, and the target component causes the computing system to generate target information associated with one or more potential financial transactions based at least partially on the plurality of terms, and transmit the target information to one or more promotion systems such that the one or more promotion systems are configured to generate one or more promotions associated with the one or more users based at least partially on the target information.

In yet another aspect, a computer-implemented method is provided for generating one or more time-bound predictions to facilitate one or more financial transactions. The computer-implemented method includes retrieving one or more social media posts associated with one or more users, extracting a plurality of terms from a first post of the one or more social media posts, analyzing the plurality of terms to determine whether the first post is associated with a potential financial transaction, using the plurality of terms to generate target information associated with the potential financial transaction, and transmitting the target information to one or more promotion systems such that the one or more promotion systems are configured to use the target information to generate one or more promotions associated with a first user associated with the first post.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example environment for processing financial transactions.

FIG. 2 is a block diagram illustrating an example ecosystem for using social media data patterns to generate time-bound predictions in an environment, such as the environment shown in FIG. 1.

FIG. 3 is a block diagram illustrating a plurality of example components that may be used to generate time-bound predictions.

FIG. 4 is a flowchart of an example method for generating time-bound predictions using a computing system, such as a computing system that includes the components shown in FIG. 3.

FIG. 5 is a detailed flowchart of the method shown in FIG. 4.

FIG. 6 is a block diagram illustrating an example operating environment in which time-bound predictions may be generated based on social media data patterns.

Corresponding reference characters indicate corresponding parts throughout the drawings.

### DETAILED DESCRIPTION

The subject matter described herein relates to using social media data patterns to generate time-bound predictions. Embodiments of the disclosure enable one or more promotions to be generated based on the time-bound predictions, thereby potentially increasing an effectiveness of the promotions. The promotions may include, for example, an advertisement that encourages a cardholder to purchase goods and/or services. Embodiments described herein may utilize social media data to identify one or more potential financial transactions and generate target information associated with the potential financial transactions.

Aspects of the disclosure provide for a computing system that performs one or more operations in an environment including a plurality of devices coupled to each other via a network (e.g., a local area network (LAN), a wide area network (WAN), the Internet). For example, embodiments of the disclosure may retrieve one or more social media feeds from one or more content systems, and transmit target information associated with the social media feeds to one or more promotion systems. In this manner, published content may be used to automatically identify one or more actionable opportunities to facilitate one or more financial transactions.

The systems and processes described herein may be implemented using computer programming or engineering techniques including computer software, firmware, hardware or a combination or subset thereof. At least one technical problem with known computing systems is that it can be difficult, time-consuming, and/or onerous to process large volumes of data to identify one or more actionable opportunities tailored to one or more users. The embodiments described herein address at least this technical problem.

By generating time-bound predictions in the manner described in this disclosure, some embodiments improve user experience, user efficiency, and/or user interaction performance by having a computing system that processes published content to identify one or more actionable opportunities that are tailored to a user without prompting the user to provide additional input. Additionally, some embodiments improve cardholder confidence in financial institutions by using data that may be indicative of the purchasing tendencies of a cardholder. In this manner, the embodiments described herein may facilitate promoting convenience to a user by automatically generating target information in an efficient and user-friendly manner.

Moreover, some embodiments may reduce network bandwidth usage by reducing an amount of data to be transmitted, improve communication between systems by using a central computing system to control communications, reduce processor load by reducing an amount of data to be analyzed or processed, improve data integrity by managing access to various accounts, and/or reduce error rate by automating the processing and analysis of large volumes of data and simplifying the promotion generation process. In some embodiments, the subject matter described herein may facilitate increasing processor security, increasing processor speed, and/or improving operating system resource allocation.

The technical effect of the systems and processes described herein is achieved by performing at least one of the following operations: a) identify account data associated with one or more user accounts; b) identify one or more social media feeds associated with one or more users; c) retrieve the social media feeds; d) extract a plurality of terms from a social media post included in the social media feeds; e) analyze the terms to determine whether the social media post is associated with a potential financial transaction; f) identify an opportunity to support the plurality of terms; g) retrieve account data associated with the user that supports the plurality of terms; h) generate target information associated with the potential financial transaction; i) generate derivative target information associated with the classifications; j) generate a confidence score associated with the target information; k) determine a weight associated with a reliability of the confidence score; l) categorize the target information into one or more classifications; m) identify the one or more promotion systems; and n) transmit the target information to one or more promotion systems.

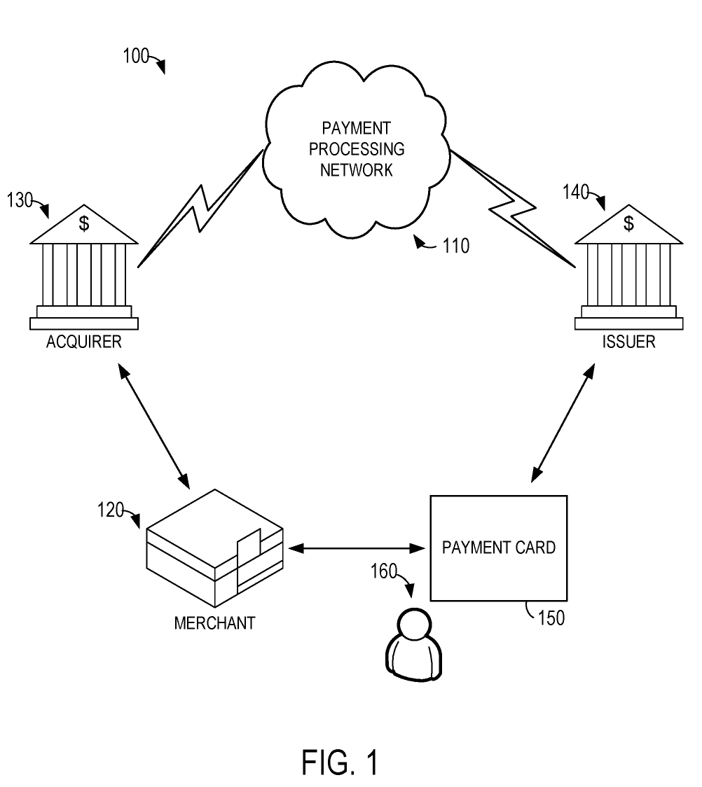

FIG. 1 is a block diagram illustrating an example environment 100 for processing one or more financial transactions. The environment 100 includes a processing network 110, such as the MASTERCARD® brand payment processing network (MASTERCARD® is a registered trademark of MasterCard International Incorporated located in Purchase, N.Y.). The MASTERCARD® brand payment processing network is a propriety network for exchanging financial transaction data between members of the MASTERCARD® brand payment processing network.

The environment 100 includes one or more merchants 120 that accept payment via the processing network 110. To accept payment via the processing network 110, the merchant 120 establishes a financial account with an acquirer 130 that is a member of the processing network 110. The acquirer 130 is a financial institution that maintains a relationship with one or more merchants 120 to enable the merchants 120 to accept payment via the processing network 110. The acquirer 130 may also be known as an acquiring bank, a processing bank, or a merchant bank.

The environment 100 includes one or more issuers 140 that issue or provide payment cards 150 (e.g., credit card, debit card, prepaid card, and the like) or other payment products to one or more cardholders 160 or, more broadly, account holders (“cardholder” and “account holder” may be used interchangeably herein). The issuer 140 is a financial institution that maintains a relationship with one or more cardholders 160 to enable the cardholders 160 to make a payment using the payment card 150 via the processing network 110.

A cardholder 160 uses a payment product, such as a payment card 150, to purchase a good or service from a merchant 120. In some embodiments, the payment card 150 is linked or associated with electronic wallet technology or contactless payment technology, such as a radio frequency identification (RFID)-enabled device, a BLUETOOTH® brand wireless technology-enabled device, a ZIGBEE® brand communication-enabled device, a WI-FI® brand local area wireless computing network-enabled device, a near field communication (NFC) wireless communication-enabled device, and/or any other device that enables the payment card 150 to purchase a good or service from a merchant 120. (BLUETOOTH® is a registered trademark of Bluetooth Special Interest Group, ZIGBEE® is a registered trademark of the ZigBee Alliance, and WI-FI® is a registered trademark of the Wi-Fi Alliance). The cardholder 160 may use any payment product that is linked or associated with a corresponding cardholder account maintained by an issuer 140. As described herein, the term “payment card” includes credit cards, debit cards, prepaid cards, digital cards, smart cards, and any other payment product that is linked or associated with a corresponding cardholder account maintained by an issuer 140. Payment cards 150 may have any shape, size, or configuration that enables the environment 100 to function as described herein.

A cardholder 160 may present the merchant 120 with a payment card 150 to make a payment to the merchant 120 in exchange for a good or service. Alternatively, the cardholder 160 may provide the merchant 120 with account information associated with the payment card 150 without physically presenting the payment card 150 (e.g., for remote financial transactions including e-commerce transactions, card-not-present transactions, or card-on-file transactions). Account information may include a name of the cardholder 160, an account number, an expiration date, and/or a security code (such as a card verification value (CVV), a card verification code (CVC), and the like).

The merchant 120 requests authorization from an acquirer 130 for at least the amount of the purchase. The merchant 120 may request authorization using any financial transaction computing device configured to transmit the account information of the cardholder 160 to one or more financial transaction processing computing devices of the acquirer 130. For example, the merchant 120 may request authorization through a point-of-sale (POS) terminal, which reads account information from a microchip or magnetic stripe on the payment card 150, and transmits the account information to the one or more financial transaction processing computing devices of the acquirer 130. For another example, the POS terminal reads account information from a device configured to communicate with the POS terminal using contactless payment technology, and transmits the account information to one or more financial transaction processing computing devices of the acquirer 130.

Using the processing network 110, the financial transaction processing computing devices of the acquirer 130 communicate with one or more financial transaction processing computing devices of an issuer 140 to determine whether the account information matches or corresponds to the account information of the issuer 140, whether the cardholder account is in good standing, and/or whether the purchase is covered by (e.g., less than) a credit line or account balance associated with the cardholder account. Based on these determinations, the financial transaction processing computing devices of the issuer 140 determine whether to approve or decline the request for authorization from the merchant 120.

If the request for authorization is declined, the merchant 120 is notified as such, and may request authorization from the acquirer 130 for a lesser amount or request an alternative form of payment from the cardholder 160. If the request for authorization is approved, an authorization code is issued to the merchant 120, and the cardholder's available credit line or account balance is decreased. The financial transaction is then settled between the merchant 120, the acquirer 130, the issuer 140, and/or the cardholder 160. Settlement typically includes the acquirer 130 reimbursing the merchant 120 for selling the good or service, and the issuer 140 reimbursing the acquirer 130 for reimbursing the merchant 120. When a credit card is used, the issuer 140 may bill the cardholder 160 to settle the cardholder account (e.g., a credit card account). When a debit or prepaid card is used, the issuer 140 may automatically withdraw funds from the cardholder account (e.g., a checking account, a savings account).

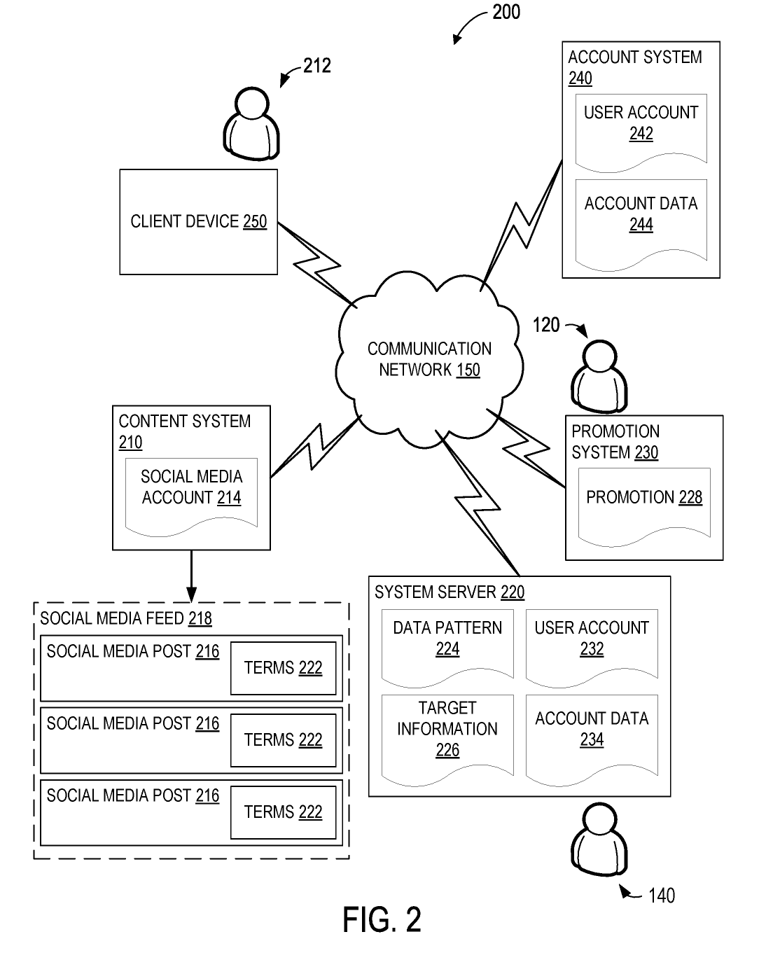

FIG. 2 is a block diagram illustrating an example ecosystem 200 for generating one or more time-bound predictions to facilitate one or more financial transactions in the environment 100. The ecosystem 200 includes one or more content systems 210 that enable a user 212 (e.g., a cardholder 160) to generate and disseminate content in a virtual environment (e.g., on the Internet). A content system 210 storing and maintaining one or more social media accounts 214 (e.g., a first content system), for example, enables one or more users 212 associated with the social media accounts 214 to generate and share one or more social media posts 216 with one or more other users 212. Additionally or alternatively, a content system 210 may store or maintain any type of account that enables a user 212 to publish content, such as a website account, a web log (“blog”) account, a video blog (“vlog”) account, a mobile phone blog (“mo-blog”) account, an Internet forum (e.g., discussion board, message board) account, and the like. As described herein, the term “social media” refers to a medium or other mechanism that allows a user 212 to publish content (e.g., text, photo, audio, video) in a virtual environment such that one or more other users 212 have access to the published content.

The content system 210 may arrange one or more social media posts 216 associated with (e.g., generated by, shared by, shared with) one or more users 212 to generate one or more social media feeds 218, and publish the social media feeds 218 in the virtual environment. In some embodiments, the content system 210 disseminates the social media feeds 218 to or through a social network including a plurality of users 212. Each user 212 may be associated with, for example, a respective social media account 214 having one or more permission levels that control dissemination of one or more social media posts 216 shared by the user 212 and/or control access to one or more social media posts 216 shared with the user 212.

The ecosystem 200 includes a system server 220 that retrieves one or more social media feeds 218 for generating one or more time-bound predictions. In some embodiments, the system server 220 identifies one or more social media posts 216 included in the social media feeds 218, and analyzes the social media posts 216 to determine whether the social media posts 216 are associated with one or more potential financial transactions. For example, the system server 220 may extract a plurality of terms 222 from a social media post 216 included in the social media feeds 218 (e.g., a first social media post), and analyze the terms 222 to identify one or more data patterns 224 associated with the social media post 216.

If a data pattern 224 associated with the social media post 216 indicates a user desire to enter into a financial transaction, the system server 220 may determine that the social media post 216 is associated with a potential financial transaction, and generate one or more time-bound predictions associated with the potential financial transaction. A data pattern 224 including product data, temporal data, and location data, for example, may indicate a user desire to enter into a financial transaction for obtaining or receiving a good or service associated with the product data within a time period associated with the temporal data and in a setting (e.g., at a geolocation, with a particular merchant 120) associated with the location data.

In some embodiments, the system server 220 uses one or more data patterns 224 to generate target information 226 associated with one or more potential financial transactions. Target information 226 including product data, temporal data, and location data, for example, may be used to generate one or more promotions 228 that are configured to encourage one or more users 212 to enter into one or more financial transactions. In some embodiments, the system server 220 communicates with one or more promotion systems 230 to transmit, to the promotion systems 230, the target information 226 such that the promotion systems 230 are configured to generate one or more promotions 228 targeted to the users 212 based on the target information 226. A merchant 120, for example, may be associated with one or more promotion systems 230 for generating one or more promotions 228 to encourage the users 212 to purchase goods and/or services.

In some embodiments, the system server 220 stores and maintains one or more user accounts 232 associated with one or more users 212. For example, the system server 220 may be associated with an issuer 140, and/or the user accounts 232 may include one or more cardholder accounts that are associated with one or more cardholders 160. Additionally or alternatively, the system server 220 may be associated with any entity, and/or the user accounts 232 may be associated with any type of user account, such as a financial account, a checking account, a savings account, a brokerage account, a merchant loyalty account, an insurance account, a membership account, a resident account, an employee account, and the like.

The system server 220 may use account data 234 associated with the user accounts 232 to supplement, enhance, or otherwise support one or more terms 222 and/or data patterns 224 for generating the target information 226. Account data 234 associated with one or more cardholder accounts, for example, may include profile data, such as identifier data (e.g., account number) and location data (e.g., billing address), and/or transaction data, such as product data (e.g., product identifier, product description), temporal data (e.g., transaction date), and location data (e.g., delivery address, merchant location), that may be used to generate at least a portion of the target information 226 and/or provide context for at least some data patterns 224.

In some embodiments, the system server 220 uses the account data 234 to communicate with one or more account systems 240 that store and maintain one or more other user accounts 242 associated with the users 212 to retrieve, from the account systems 240, account data 244 associated with the other user accounts 242, in accordance with applicable data privacy laws and regulations. The account data 244 may be used, for example, to supplement, enhance, or otherwise support the data patterns 224 and/or account data 234 for generating the target information 226. The user accounts 242 may be associated with any type of user account, such as a cardholder account, a financial account, a checking account, a savings account, a brokerage account, a merchant loyalty account, an insurance account, a membership account, a resident account, an employee account, and the like.

In some embodiments, the ecosystem 200 includes a client device 250 that enables a user 212 to communicate with one or more other computing systems (e.g., content system 210, system server 220, promotion system 230, account system 240). The client device 250 may include one or more applications (“apps”) configured to communicatively couple the client device 250 to the computing systems such that data may be transmitted between the client device 250 and the computing systems. For example, a social media application may allow the user 212 to use the client device 250 to generate and share one or more social media posts 216 with one or more other users 212, and/or a payment card application may allow the user 212 to use the client device 250 to enter into one or more financial transactions.

In some embodiments, the client device 250 includes an operating system that enables the user 212 to use the applications in a user-friendly manner. For example, the operating system may include one or more application program interfaces (APIs) that enable the client device 250 to present information to and/or obtain user input from the user 212 (e.g., via a graphical user interface) and/or to transmit data to and/or receive data from one or more other computing systems (e.g., via a network interface), such as the content system 210, the system server 220, the promotion system 230, and/or the account system 240.

The ecosystem 200 includes one or more communication networks 260 that enable data to be transferred between a plurality of computing systems coupled to the communication network 260 (e.g., content system 210, system server 220, promotion system 230, account system 240, client device 250). Example communication networks 260 include a cellular or mobile network and the Internet. Alternatively, the communication networks 260 may include any communication medium that enables the ecosystem 200 to function as described herein including, for example, a personal area network (PAN), a LAN, and/or a WAN.

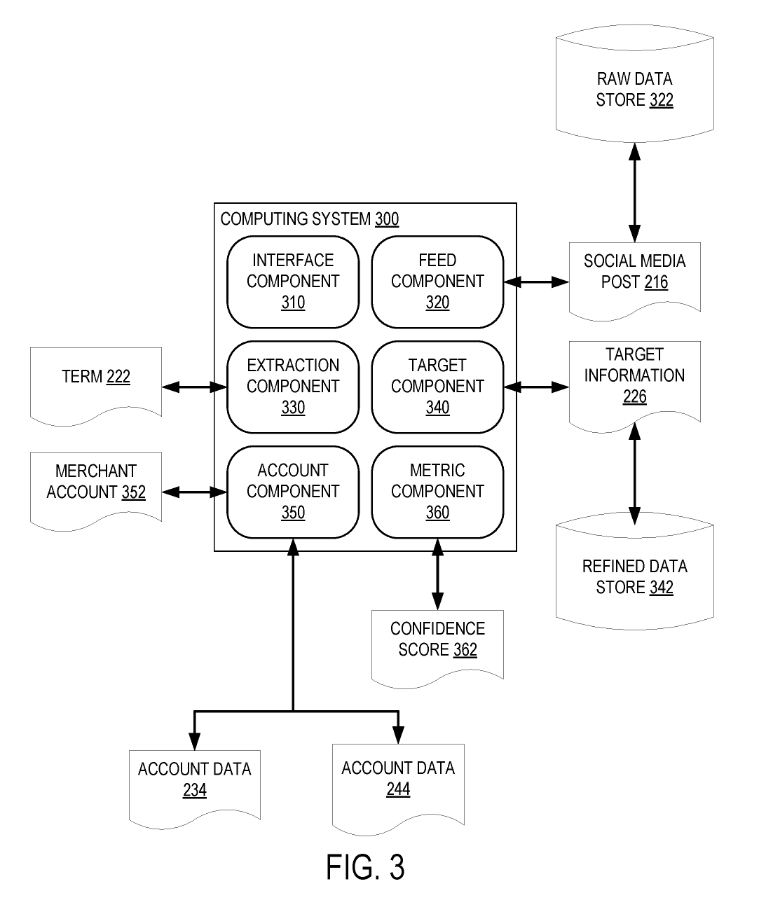

FIG. 3 is a block diagram illustrating a computing system 300 (e.g., a system server 220) that includes an interface component 310, a feed component 320, an extraction component 330, a target component 340, an account component 350, and/or a metric component 360 that may be used to generate one or more time-bound predictions. In some embodiments, the interface component 310 enables the computing system 300 to receive data from and/or transmit data to one or more other computing systems (e.g., content system 210, promotion system 230, account system 240, client device 250). For example, the interface component 310 may be coupled to another computing system to facilitate communication between the other computing system and the feed component 320, extraction component 330, target component 340, account component 350, and/or metric component 360. Additionally or alternatively, the interface component 310 may facilitate communication between and among the feed component 320, extraction component 330, target component 340, account component 350, and/or metric component 360.

The feed component 320 enables the computing system 300 to retrieve content (e.g., social media posts 216) associated with one or more users 212. In some embodiments, the feed component 320 communicates (e.g., via the interface component 310) with one or more content systems 210 to obtain, from the content systems 210, content associated with the users 212. For example, the feed component 320 may use one or more user identifiers (e.g., usernames, handles) to identify one or more social media posts 216 that are associated with the users 212 and retrieve, from one or more content systems 210, one or more social media feeds 218 that include the social media posts 216. User identifiers associated with one or more users 212 may be registered, for example, with the computing system 300 to enable the feed component 320 to identify content associated with the users 212 based on the user identifiers. In some embodiments, the feed component 320 stores the retrieved content in one or more raw data stores 322 included in and/or coupled to the computing system 300.

The extraction component 330 enables the computing system 300 to identify one or more social media posts 216 associated with one or more potential financial transactions. The extraction component 330 may communicate (e.g., via the interface component 310), for example, with the feed component 320 to obtain, from the feed component 320, one or more social media posts 216. In some embodiments, the extraction component 330 includes a natural language processing module that extracts a plurality of terms 222 from the social media posts 216, and analyzes the terms 222 to interpret the social media posts 216 and determine whether the social media posts 216 are associated with one or more potential financial transactions. The extraction component 330 may identify a social media post 216 as being associated with one or more potential financial transactions if, for example, the social media post 216 includes or is associated with product data, temporal data, and/or location data.

In some embodiments, the extraction component 330 analyzes the social media posts 216 (e.g., to determine whether the social media posts 216 are associated with one or more potential financial transactions) if the users 212 associated with the social media posts 216 are registered with the computing system 300. A social media post 216 may be associated with a user 212 if, for example, the social media post 216 was generated by the user 212, shared by the user 212, and/or shared with the user 212. In some embodiments, the extraction component 330 identifies a first user identifier (e.g., usernames, handles) associated with a social media post 216, and compares the first user identifier with one or more second user identifiers registered with the computing system 300 to determine whether a user 212 associated with the social media post 216 is registered with the computing system 300.

If a first user identifier associated with a social media post 216 corresponds to a second user identifier registered with the computing system 300, the extraction component 330 may determine that the user 212 associated with the social media post 216 is registered with the computing system 300 and analyze the social media post 216 to determine whether the social media post 216 is associated with a potential financial transaction. If, on the other hand, the first user identifier does not correspond to a second user identifier, the extraction component 330 may determine that the user 212 associated with the social media post 216 is not registered with the computing system 300.

The target component 340 enables the computing system 300 to generate target information 226 associated with one or more users 212. In some embodiments, the target component 340 communicates (e.g., via the interface component 310) with the extraction component 330 to selectively process one or more social media posts 216 associated with one or more potential financial transactions. The target component 340 may identify one or more social media posts 216 that are associated with one or more potential financial transactions, and use one or more data patterns 224 associated with the social media posts 216 to generate target information 226 associated with one or more potential financial transactions. Target information 226 may include, for example, identifier data, product data, temporal data, and/or location data.

The target information 226 may be used to generate one or more promotions 228 associated with the users 212. For example, the target component 340 may use the target information 226 to generate, at the computing system 300, one or more promotions 228 that are configured to encourage one or more users 212 to enter into one or more financial transactions. Additionally or alternatively, the target component 340 may communicate (e.g., via the interface component 310) with one or more promotion systems 230 to provide, to the promotion systems 230, target information 226. In this manner, one or more promotions 228 may be generated based on the target information 226 at one or more promotion systems 230.

In some embodiments, the target component 340 uses the target information 226 to selectively identify one or more promotion systems 230, and provides the target information 226 to the identified promotion systems 230. For example, product data included in the target information 226 may be used to identify a promotion system 230 associated with a merchant 120 that offers a good or service associated with the product data (e.g., based on product name, product brand, product category). For another example, temporal data included in the target information 226 may be used to identify a promotion system 230 associated with a merchant 120 that is available to enter into a financial transaction within a time period associated with the temporal data (e.g., based on inventory level or appointment schedule). For yet another example, location data included in the target information 226 may be used to identify a promotion system 230 associated with a merchant 120 that is associated with the location data (e.g., based on merchant name) or that is in a geolocation associated with the location data (e.g., based on user geolocation or merchant geolocation).

In some embodiments, the target information 226 is categorized into one or more classifications based on the information included in the target information 226 (e.g., product data, temporal data, location data). In this manner, the target information 226 may be transmitted to one or more promotion systems 230 based at least partially on the classifications. A plurality of target information 226 that share a classification may be aggregated and analyzed collectively as a group to generate target information 226 associated with the classification (e.g., a derivative target information). In some embodiments, the target component 340 stores the target information 226 in one or more refined data stores 342 included in and/or coupled to the computing system 300.

The account component 350 enables the computing system 300 to access and/or use account data 234 and/or account data 244 to supplement, enhance, or otherwise support one or more terms 222 and/or data patterns 224 for generating the target information 226. Account data 234 stored and maintained at the computing system 300 may include, for example, data registered with the computing system 300, such as credential data and/or contact data. Credential data includes any data that enables any entity (merchant 120, issuer 140, cardholder 160, user 212) to be identified and/or authenticated, such as an identifier, an account number, a public key infrastructure (PKI) certificate, a password, a personal identification number (PIN), a token, and/or biometric data. For example, credential data may be used to selectively allow one or more users 212 to access and use account data 234 associated with one or more user accounts 232. Contact data includes any data that enables any entity (e.g., content system 210, promotion system 230, account system 240, client device 250) to be located and/or approached for communicating with the entity, such as an identifier, a routing number, a media access controller (MAC) address, an Internet Protocol (IP) address, an email address, and/or a telephone number.

The account component 350 may use account data 234 to communicate (e.g., via the interface component 310) with one or more other computing systems (e.g., content system 210, account system 240) and obtain, from the other computing systems, data associated with one or more accounts (e.g., social media account 214, user account 242). For example, the account data 234 may include credential data and/or contact data associated with one or more social media accounts 214 for identifying or obtaining one or more social media posts 216, and/or credential data and/or contact data associated with one or more user accounts 242 for identifying or obtaining account data 244.

In some embodiments, the account component 350 communicates (e.g., via the interface component 310) with the target component 340 to provide, to the target component 340, account data 234 and/or account data 244 and enable the target component 340 to generate target information 226 based on the account data 234 and/or account data 244. Additionally or alternatively, the account component 350 may obtain one or more terms 222 extracted from a social media post 216 and/or one or more data patterns 224 associated with the social media post 216, and determine whether account data 234 and/or account data 244 may be used to supplement, enhance, or otherwise support the terms 222 and/or data patterns 224 for generating the target information 226. The account component 350 may identify, for example, one or more other computing systems for obtaining the account data 244 if, for example, it is determined that account data 244 may be used to support the terms 222 and/or data patterns 224.

In some embodiments, the account component 350 manages one or more merchant accounts 352 associated with one or more merchants 120. The account component 350 may use data (e.g., account data) associated with the merchant accounts 352, for example, to communicate (e.g., via the interface component 310) with one or more other computing systems (e.g., promotion system 230) and provide, to the other computing systems, target information 226. Credential data associated with the merchant accounts 352, for example, may be used to selectively allow one or more merchants 120 to access and use account data associated with the merchant accounts 352.

The metric component 360 enables the computing system 300 to characterize the target information 226. In some embodiments, the metric component 360 compares the target information 226 with one or more parameters that set or define one or more boundaries or thresholds of expected user behavior to assign or generate one or more confidence scores 362 associated with the target information 226. The confidence scores 362 may indicate, for example, a likelihood of a potential financial transaction materializing as a completed financial transaction.

TABLE 1

| Purchase Price (p) | Price Metric (PM) |
|---|---|
| p < $50 | 90% |
| $50 ≤ p < $100 | 60% |
| $100 ≤ p < $5,000 | 40% |
| p ≥ $5,000 | 20% |

For one example, the confidence scores 362 may include a price metric PM that indicates a probability of a potential financial transaction materializing as a completed financial transaction based on a purchase price p of a product, where, as illustrated in Table 1, a lower purchase price p is associated with a higher price metric PM and a higher purchase price p is associated with a lower price metric PM. Additionally or alternatively, the price metric PM may be generated based on a user capacity to purchase the product. The user capacity may be associated with, for example, a credit limit of a credit card associated with a user 212 and/or an account balance of a debit card, prepaid card, checking account, and/or savings account associated with the user 212.

TABLE 2

| Purchase Timeframe (t) | Time Metric (TM) |
|---|---|
| t < 1 month | 90% |
| 1 month ≤ t < 6 months | 60% |
| 6 months ≤ t < 12 months | 40% |
| t ≥ 12 months | 20% |

TABLE 3

| Purchase Distance (d) | Distance Metric (DM) |
|---|---|
| l < 5 miles | 90% |
| 5 miles ≤ l < 20 miles | 60% |
| 20 miles ≤ l < 100 miles | 40% |
| l ≥ 100 miles | 20% |

Other examples of a confidence score 362 include a time metric TM that indicates the probability based on a purchase timeframe t of a product, and a distance metric DM that indicates the probability based on a purchase distance d of the product. As illustrated in Table 2, a more immediate purchase timeframe t is associated with a higher time metric TM and a more remote purchase timeframe t is associated with a lower time metric TM. And, as illustrated in Table 3, a more proximate purchase distance d is associated with a higher distance metric DM and a more distant purchase distance d is associated with a lower distance metric DM. In this manner, a price metric PM may be indicative of a user ability to enter into a financial transaction, a time metric TM may be indicative of a user urgency to enter into the financial transaction, and/or a distance metric DM may be indicative of a user convenience to enter into the financial transaction.

In some embodiments, the metric component 360 uses a plurality of confidence scores 362 (e.g., price metric PM, time metric TM, distance metric DM) to calculate or generate a composite index associated with the likelihood of the potential financial transaction materializing as a completed financial transaction based on a plurality of factors associated with the confidence scores 362 (e.g., purchase price p, purchase timeframe t, purchase distance d, respectively). For example, a composite index for a target information 226 associated with a product having a purchase price p of $75.00, a purchase timeframe t of 9 months, and a purchase distance d of 2 miles may be generated by using Tables 1, 2, and 3 to identify a corresponding price metric PM of 60%, a corresponding time metric TM of 40%, and a distance metric DM of 90%, and multiplying the price metric PM by the time metric TM and the distance metric DM.

Other data, including data used to generate the target information 226 (e.g., data included in a data pattern 224 associated with a social media post 216, account data 234 and/or account data 244 that supplements, enhances, or otherwise supports a term 222 and/or data pattern 224), may be used to adjust one or more confidence scores 362. For example, if a transaction history including a repeat purchase pattern associated with the product is identified, the metric component 360 may increase the composite index to indicate an increased likelihood of the potential financial transaction materializing as a completed financial transaction.

In some embodiments, the metric component 360 calculates or generates one or more weights for adjusting the confidence scores 362. The weights may indicate, for example, a reliability of or a confidence in the confidence scores 362. If data used to generate the target information 226 and/or the confidence score 362 is consistent with a larger quantity of other data (e.g., data used to generate other target information 226 and/or confidence scores 362), the metric component 360 may have more confidence in the confidence score 362 and, thus, assign a greater weight to the confidence score 362. If, on the other hand, the data used to generate the confidence score 362 is consistent with a smaller quantity of other data and/or inconsistent with a larger quantity of other data, the metric component 360 may have less confidence in the confidence score 362 and, thus, assign a lesser weight to the confidence score 362.

Tables 1, 2, and 3 are illustrative. In some embodiments, the metric component 360 modifies one or more factors (e.g., Tables 1, 2, and/or 3, weights), including adding or removing one or more factors, to facilitate increasing an accuracy of the confidence scores 362. The metric component 360 may compare, for example, transaction data with the target information 226 to determine whether one or more potential financial transactions match or correlate with one or more financial transactions associated with the transaction data (e.g., completed financial transactions). If a potential financial transaction correlates with a completed financial transaction, transaction data associated with the completed financial transaction may be used to modify one or more factors. Additionally or alternatively, one or more factors may be modified based on a conversion rate associated with one or more potential financial transactions materializing as a completed financial transaction. If, on the other hand, a potential financial transaction does not correlate with a completed financial transaction, one or more factors may be modified, for example, based on target information 226.

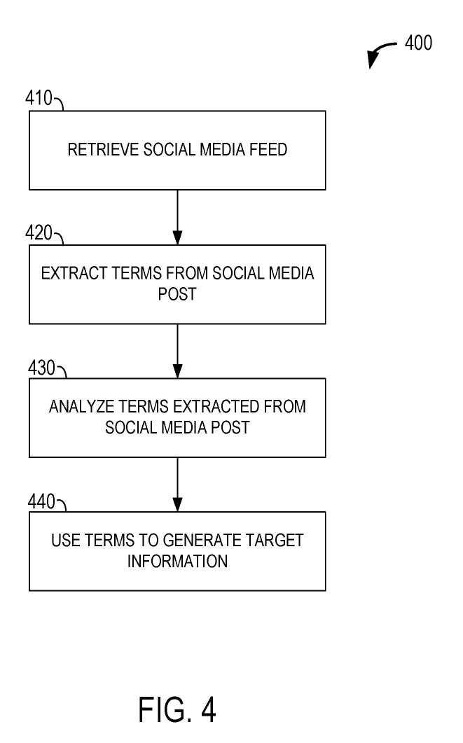

FIG. 4 is a flowchart of an example method 400 for generating one or more time-bound predictions using a computing system 300 (shown in FIG. 2). In some embodiments, one or more social media feeds 218 are retrieved at 410 from one or more content systems 210. The social media feeds 218 may include one or more social media posts 216 associated with one or more users 212.

A plurality of terms 222 are extracted at 420 from the social media posts 216, and analyzed at 430 to determine whether the social media posts 216 are associated with one or more potential financial transactions. For example, the computing system 300 may analyze the terms 222 to identify one or more data patterns 224 associated with the social media posts 216, and determine that the social media posts 216 are associated with one or more potential financial transactions when the data pattern 224 includes product data, temporal data, and/or location data.

On condition that a social media post 216 is associated with a potential financial transaction, the terms 222 extracted from the social media post 216 are used at 440 to generate target information 226 associated with the potential financial transaction. In some embodiments, the target information 226 is transmitted to one or more promotion systems 230 such that the promotion systems 230 are configured to use the target information 226 to generate one or more promotions 228 tailored to the user 212.

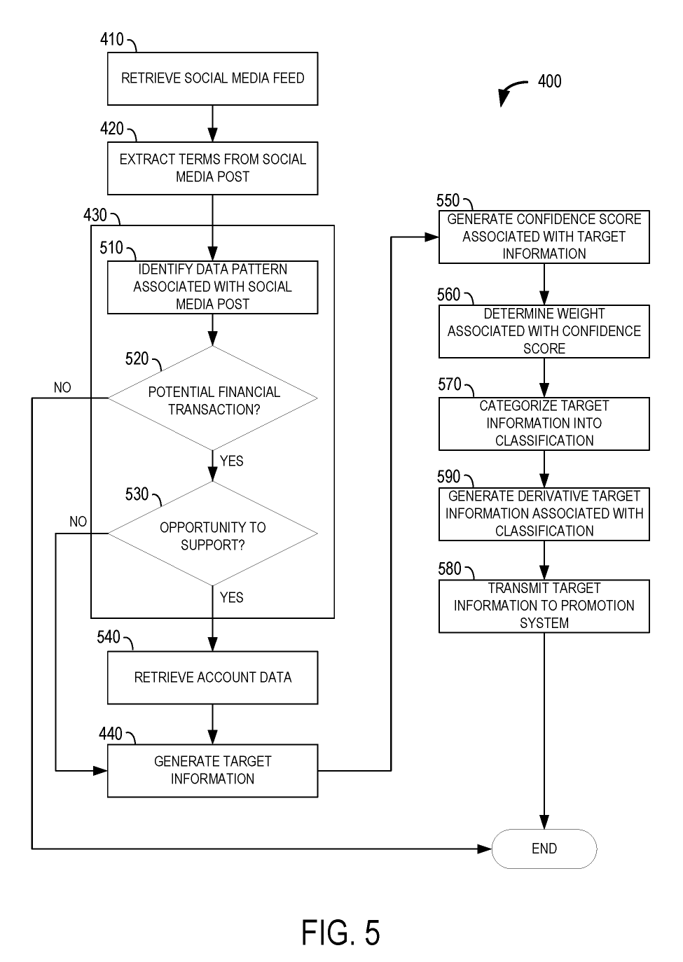

FIG. 5 is a detailed flowchart of the method 400. In some embodiments, one or more users 212 (e.g., a cardholder 160) enroll or register in a program to receive one or more promotions 228 targeted to the users 212. Additionally or alternatively, one or more merchants 120 may enroll or register in the program to receive target information 226 that enables the merchants 120 to provide one or more promotions 228 targeted to one or more users 212.

One or more social media feeds 218 including one or more social media posts 216 associated with one or more users 212 are retrieved at 410 from one or more content systems 210. A social media post 216 may be identified as being associated with a user 212 when the social media post 216 is generated by the user 212, shared by the user 212, and/or shared with the user 212. In some embodiments, one or more social media posts 216 associated with a user 212 are identified and the identified social media posts 216 are retrieved. Social media posts 216 associated with the user 212 may be identified, for example, using account data 234 (e.g., username, handle) associated with the user 212. Additionally or alternatively, the computing system 300 may retrieve one or more social media posts 216 and then use the account data 234 to identify or select, from the retrieved social media posts 216, the social media posts 216 associated with the user 212. The social media posts 216 may include, for example, a first social media post 216 (i.e., Social Media Post “1”) that recites, “I want to buy [brand name] sunglasses, and I heard [merchant name] might have them on sale soon.”, and a second social media post 216 (i.e., Social Media Post “2”) that recites, “I'd like to buy a new television before the big game.”

TABLE 4
Extracted Terms

| Social | | | |
|---|---|---|---|
| Media Post | Product Data | Time Data | Location Data |
| 1 | [brand name] | soon | [merchant name] |
| | sunglasses | | |
| 2 | television | before the big game | |

In some embodiments, a plurality of terms 222 are extracted at 420 from the social media posts 216. Table 4 includes a plurality of terms 222 extracted from Social Media Post 1 and Social Media Post 2. The terms 222 may be analyzed at 430 to identify at 510 one or more data patterns 224 associated with the social media posts 216. It may be determined at 520, for example, that a social media post 216 is associated with one or more potential financial transactions if a data pattern 224 associated with the social media post 216 includes product data, temporal data, and/or location data. On the other hand, it may be determined that a social media post 216 is not associated with one or more potential financial transactions if the data pattern 224 associated with the social media post 216 does not include product data, temporal data, or location data.

The terms 222 extracted from a social media post 216 associated with a potential financial transaction are used at 440 to generate target information 226 associated with the potential financial transaction. The target information 226 may include, for example, product data (e.g., product type, purchase price p), temporal data (e.g., purchase timeframe t), and/or location data (e.g., user geolocation, merchant geolocation, purchase distance d). For example, the computing system 300 may identify “[brand name] sunglasses” and “television” as being associated with product types, and interpret “soon” to indicate a timeframe (e.g., purchase timeframe t) of one week.

TABLE 5
Target Information

| Social | | | |
|---|---|---|---|
| Media Post | Product Data | Time Data | Location Data |
| 1 | Product type: | Purchase | User geolocation: |
| | [brand name] | timeframe: | [billing address] |
| | sunglasses | 1 week | Merchant |
| | Purchase price: $75 | | geolocation: |
| | | | [merchant address 1] |
| | | | Purchase distance: 3 |
| | | | miles |
| 2 | Product type: | Purchase | User geolocation: |
| | television | timeframe: 2 | [billing address] |
| | Purchase price: | months | Merchant |
| | $1,000 | | geolocation: |
| | | | [merchant address 2] |
| | | | Purchase distance: 6 |
| | | | miles |

When an opportunity to supplement, enhance, or otherwise support the terms 222 and/or data patterns 224 is identified at 530, other data (e.g., account data 234, account data 234) may be retrieved at 540 and used to generate at least a portion of the target information 226. For example, the computing system 300 may identify other data that support the terms 222 and/or data patterns 224, and use the other data to determine a price (e.g., purchase price p) associated with the product type, identify a date associated with a named event (e.g., “the big game”) to determine a timeframe between a present date and the identified date, identify a user geolocation (e.g., billing address) associated with the user 212 and a merchant geolocation (e.g., merchant address 1) associated with a named merchant 120 (e.g., [merchant name]) to determine a distance (e.g., purchase distance d) between the user geolocation and the merchant geolocation, and/or identify a merchant 120 that is available to offer a named product (e.g., “television”) and that is convenient to the user 212 based on the distance between the user geolocation and a merchant geolocation (e.g., merchant address 2) associated with the identified merchant 120. Table 5 includes target information 226 generated based on the terms 222 extracted from Social Media Post 1 and Social Media Post 2 and other data associated with the terms 222.

TABLE 6
Confidence Scores

| Social | | | Distance Metric |
|---|---|---|---|
| Media Post | Price Metric (PM) | Time Metric (TM) | (DM) |
| 1 | 60% | 90% | 90% |
| 2 | 40% | 60% | 60% |

In some embodiments, the target information 226 is associated with one or more confidence scores 362. The confidence scores 362 may be generated at 550, for example, to indicate a likelihood of a potential financial transaction materializing as a completed financial transaction. Table 6 includes a plurality of confidence scores 362 generated using Tables 1-3 for the target information 226 associated with Social Media Post 1 and Social Media Post 2. In some embodiments, one or more weights are determined at 560 for adjusting the confidence scores 362 based on one or more reliabilities of or confidences in the confidence scores 362.

Target information 226 may be categorized at 570 into one or more classifications, and transmitted at 580 to one or more promotion systems 230 based on the classifications. For example, the computing system 300 may categorize target information 226 and/or identify the promotion systems 230 based on one or more criteria, such as product data, temporal data, and/or location data. In some embodiments, a plurality of target information 226 sharing a classification are aggregated and analyzed as a group to generate at 590 target information 226 associated with the classification (e.g., derivative target information). Derivative target information 226 associated with a sunglasses-based classification, for example, may recite, “5,000 customers from [geolocation] are interested in buying sunglasses within a month.”

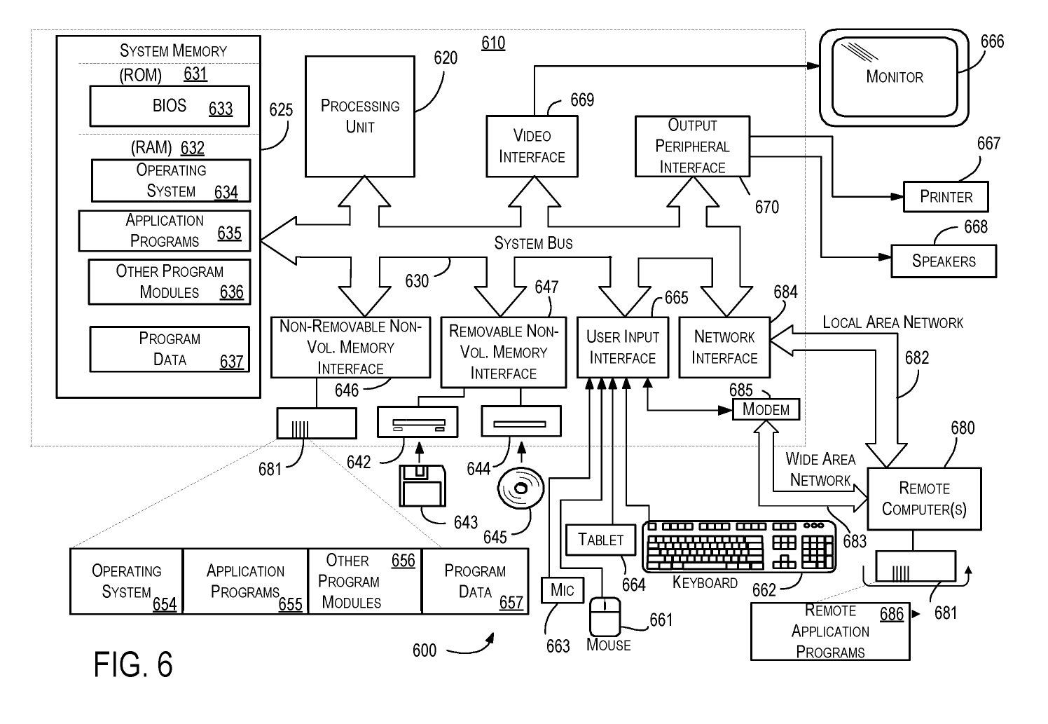

FIG. 6 is a block diagram illustrating an example operating environment 600 that may be used to generate one or more time-bound predictions. The operating environment 600 is only one example of a computing and networking environment and is not intended to suggest any limitation as to the scope of use or functionality of the disclosure. The operating environment 600 should not be interpreted as having any dependency or requirement relating to any one or combination of components illustrated in the example operating environment 600.

The disclosure is operational with numerous other computing and networking environments or configurations. While some examples of the disclosure are illustrated and described herein with reference to the operating environment 600 being or including a system server 220 (shown, e.g., in FIG. 2) and/or a computing system 300 (shown in FIG. 3), aspects of the disclosure are operable with any computing device (e.g., content system 210, promotion system 230, account system 240, client device 250) that executes instructions to implement the operations and functionality associated with the operating environment 600.

For example, the operating environment 600 may include a mobile device, a smart watch or device, a mobile telephone, a phablet, a tablet, a portable media player, a netbook, a laptop, a desktop computer, a personal computer, a server computer, a computing pad, a kiosk, a tabletop device, an industrial control device, a multiprocessor system, a microprocessor-based system, a set top box, programmable consumer electronics, a network computer, a minicomputer, a mainframe computer, a distributed computing environment that include any of the above systems or devices, and the like. The operating environment 600 may represent a group of processing units or other computing devices. Additionally, any computing device described herein may be configured to perform any operation described herein including one or more operations described herein as being performed by another computing device.

With reference to FIG. 6, an example system for implementing various aspects of the disclosure may include a general purpose computing device in the form of a computer 610. Components of the computer 610 may include, but are not limited to, a processing unit 620 (e.g., a processor), a system memory 625 (e.g., a computer-readable storage device), and a system bus 630 that couples various system components including the system memory 625 to the processing unit 620. The system bus 630 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 625 includes any quantity of media associated with or accessible by the processing unit 620. For example, the system memory 625 may include computer storage media in the form of volatile and/or nonvolatile memory, such as read only memory (ROM) 631 and random access memory (RAM) 632. The ROM 631 may store a basic input/output system 633 (BIOS) that facilitates transferring information between elements within computer 610, such as during start-up. The RAM 632 may contain data and/or program modules that are immediately accessible to and/or presently being operated on by processing unit 620. For example, the system memory 625 may store computer-executable instructions, application data, credential data, contact data, profile data, transaction data, product data, temporal data, location data, identifier data, data patterns 224, target information 226, content (e.g., social media posts 216, promotions 228), account data (e.g., account data 234, account data 244), and other data.

By way of example only, FIG. 6 illustrates a hard disk drive 641 that reads from or writes to non-removable, nonvolatile magnetic media, a magnetic disk drive 642 that reads from or writes to a removable, nonvolatile magnetic disk 643 (e.g., a floppy disk, a tape cassette), and an optical disk drive 644 that reads from or writes to a removable, nonvolatile optical disk 645 (e.g., a compact disc (CD), a digital versatile disc (DVD)). Other removable/non-removable, volatile/nonvolatile computer storage media that may be used in the example operating environment include, but are not limited to, flash memory cards, digital video tape, solid state RAM, solid state ROM, and the like. The hard disk drive 641 may be connected to the system bus 630 through a non-removable memory interface such as interface 646, and magnetic disk drive 642 and optical disk drive 644 may be connected to the system bus 630 by a removable memory interface, such as interface 647.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 654, application programs 655, other program modules 656 and program data 657. Note that these components may either be the same as or different from operating system 634, application programs 635, other program modules 636, and program data 637. Operating system 654, application programs 655, other program modules 656, and program data 657 are given different numbers herein to illustrate that, at a minimum, they are different copies.

The processing unit 620 may be programmed to execute the computer-executable instructions for implementing aspects of the disclosure, such as those illustrated in the figures (e.g., FIGS. 4 and 5). For example, the system memory 625 may include an interface component 310 (shown in FIG. 3), a feed component 320 (shown in FIG. 3), an extraction component 330 (shown in FIG. 3), a target component 340 (shown in FIG. 3), an account component 350 (shown in FIG. 3), and/or a metric component 360 (shown in FIG. 3) for implementing aspects of the disclosure. The processing unit 620 includes any quantity of processing units, and the instructions may be performed by the processing unit 620 or by multiple processors within the operating environment 600 or performed by a processor external to the operating environment 600. By way of example, and not limitation, FIG. 6 illustrates operating system 634, application programs 635, other program modules 636, and program data 637.

Upon programming or execution of these components, the operating environment 600 and/or processing unit 620 is transformed into a special purpose microprocessor or machine. For example, the feed component 320, when executed by the processing unit 620, causes the computer 610 to retrieve one or more social media posts 216; the extraction component 330, when executed by the processing unit 620, causes the computer 610 to extract a plurality of terms 222 from the social media posts 216, and determine whether the terms 222 include a data pattern 224 including product data, temporal data, and/or location data; and/or the target component 340, when executed by the processing unit 620, causes the computer 610 to generate target information 226 associated with one or more potential financial transactions, and transmit the target information 226 to one or more promotion systems 230 for generating target content (e.g., promotions 228). Although the processing unit 620 is shown separate from the system memory 625, embodiments of the disclosure contemplate that the system memory 625 may be onboard the processing unit 620 such as in some embedded systems.

The computer 610 includes a variety of computer-readable media. Computer-readable media may be any available media that may be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. ROM 631 and RAM 632 are examples of computer storage media. Computer storage media are tangible and mutually exclusive to communication media. Computer storage media for purposes of this disclosure are not signals per se. Example computer storage media includes, but is not limited to, hard disks, flash drives, solid state memory, RAM, ROM, electrically erasable programmable read-only memory (EEPROM), flash memory or other memory technology, CDs, DVDs, or other optical disk storage, magnetic cassettes, magnetic tape, magnetic disk storage or other magnetic storage devices, or any other medium which may be used to store the desired information and which may accessed by the computer 610. Computer storage media are implemented in hardware and exclude carrier waves and propagated signals. Any such computer storage media may be part of computer 610.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

A user (e.g., user 212, merchant 120, acquirer 130, issuer 140, cardholder 160) may enter commands and information into the computer 610 through one or more input devices, such as a pointing device 661 (e.g., mouse, trackball, touch pad), a keyboard 662, a microphone 663, and/or an electronic digitizer 664 (e.g., tablet). Other input devices not shown in FIG. 6 may include a joystick, a game pad, a controller, a satellite dish, a camera, a scanner, an accelerometer, or the like. These and other input devices may be coupled to the processing unit 620 through a user input interface 665 that is coupled to the system bus 630, but may be connected by other interface and bus structures, such as a parallel port, game port or a universal serial bus (USB).

Information, such as text, images, audio, video, graphics, alerts, and the like, may be presented to a user via one or more presentation devices, such as a monitor 666, a printer 667, and/or a speaker 668. Other presentation devices not shown in FIG. 6 may include a projector, a vibrating component, or the like. These and other presentation devices may be coupled to the processing unit 620 through a video interface 669 (e.g., for a monitor 666 or a projector) and/or an output peripheral interface 670 (e.g., for a printer 667, a speaker 668, and/or a vibration component) that are coupled to the system bus 630, but may be connected by other interface and bus structures, such as a parallel port, game port or a USB. In some embodiments, the presentation device is integrated with an input device configured to receive information from the user (e.g., a capacitive touch-screen panel, a controller including a vibrating component). Note that the monitor 666 and/or touch screen panel may be physically coupled to a housing in which the computer 610 is incorporated, such as in a tablet-type personal computer.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 682 and one or more wide area networks (WAN) 683, but may also include other networks. Such networking environments are commonplace in offices, enterprise-wide computer networks, intranets and the Internet.

When used in a LAN networking environment, the computer 610 is coupled to the LAN 682 through a network interface or adapter 684. When used in a WAN networking environment, the computer 610 may include a modem 685 or other means for establishing communications over the WAN 683, such as the Internet. The modem 685, which may be internal or external, may be connected to the system bus 630 via the user input interface 665 or other appropriate mechanism. A wireless networking component including an interface and antenna may be coupled through a device, such as an access point or peer computer to a LAN 682 or WAN 683. In a networked environment, program modules depicted relative to the computer 610, or portions thereof, may be stored in the remote memory storage device. By way of example, and not limitation, FIG. 6 illustrates remote application programs 686 as residing on memory storage device 681. It may be appreciated that the network connections shown are examples and other means of establishing a communications link between the computers may be used.

The block diagram of FIG. 6 is merely illustrative of an example system that may be used in connection with one or more examples of the disclosure and is not intended to be limiting in any way. Further, peripherals or components of the computing devices known in the art are not shown, but are operable with aspects of the disclosure. At least a portion of the functionality of the various elements in FIG. 6 may be performed by other elements in FIG. 6, or an entity (e.g., processor, web service, server, applications, computing device, etc.) not shown in FIG. 6.

Although described in connection with an example computing system environment, embodiments of the disclosure are capable of implementation with numerous other general purpose or special purpose computing system environments, configurations, or devices. Embodiments of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, earphones, and the like), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Embodiments of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

The embodiments illustrated and described herein as well as embodiments not specifically described herein but within the scope of aspects of the disclosure constitute example means for generating time-bound predictions. For example, the elements illustrated in FIGS. 1-3, 5, and 6, such as when encoded to perform the operations illustrated in FIGS. 4 and 5, constitute at least an example means for retrieving one or more social media feeds 218 associated with one or more users 212 (e.g., interface component 310, feed component 320); an example means for extracting a plurality of terms 222 from a social media post 216 included in the social media feeds 218 (e.g., extraction component 330); an example means for generating target information 226 associated with a potential financial transaction (e.g., target component 340); and/or an example means for transmitting the target information 226 to one or more promotion systems 230 (e.g., interface component 310, target component 340).

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In some embodiments, the operations illustrated in the drawings may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various embodiments with their associated operations, a person skilled in the art would appreciate that a combination of operations from any number of different embodiments is also within scope of the aspects of the disclosure.

What is claimed is:

1. A computing system for generating one or more time-bound predictions to facilitate one or more financial transactions, the computing system comprising:
a memory device storing data associated with one or more user accounts and computer-executable instructions; and
a processor configured to execute the computer-executable instructions to:
retrieve one or more social media feeds associated with one or more users, a first social media feed of the one or more social media feeds including one or more posts;
extract a plurality of terms from a first post of the one or more posts, the first post associated with a first user of the one or more users;
analyze the plurality of terms to determine whether the first post is associated with a potential financial transaction; and
on condition that the first post is associated with the potential financial transaction, use the plurality of terms to generate target information associated with the potential financial transaction, and transmit the target information to one or more promotion systems such that the one or more promotion systems are configured to use the target information to generate one or more promotions associated with the first user.

2. The computing system of claim 1, wherein the processor is further configured to execute the computer-executable instructions to:
identify account data associated with a first user account of the one or more user accounts; and
use the account data to identify the one or more social media feeds associated with the one or more users.

3. The computing system of claim 1, wherein the processor is further configured to execute the computer-executable instructions to:
identify an opportunity to support the plurality of terms; and
retrieve account data associated with the first user that supports the plurality of terms, wherein the target information is generated based at least partially on the account data.

4. The computing system of claim 1, wherein the processor is further configured to execute the computer-executable instructions to identify the one or more promotion systems.

5. The computing system of claim 1, wherein the processor is further configured to execute the computer-executable instructions to categorize the target information into one or more classifications, wherein the target information is transmitted to the one or more promotion systems based at least partially on the one or more classifications.

6. The computing system of claim 1, wherein the processor is further configured to execute the computer-executable instructions to:
categorize the target information into one or more classifications; and
use the target information to generate derivative target information associated with the one or more classifications.

7. The computing system of claim 1, wherein the processor is further configured to execute the computer-executable instructions to generate a confidence score associated with the target information.

8. The computing system of claim 7, wherein the processor is further configured to execute the computer-executable instructions to determine a weight associated with a reliability of the confidence score.

9. One or more computer storage media embodied with computer-executable instructions, the one or more computer storage media comprising:
a feed component that, upon execution by at least one processor, causes a computing system associated with the at least one processor to retrieve a social media feed including one or more posts associated with one or more users;
an extraction component that, upon execution by the at least one processor, causes the computing system to extract a plurality of terms from the one or more posts, and determine whether the plurality of terms include one or more of product data, temporal data, or location data; and
a target component that, upon execution by the at least one processor, causes the computing system to generate target information associated with one or more potential financial transactions based at least partially on the plurality of terms, and transmit the target information to one or more promotion systems such that the one or more promotion systems are configured to generate one or more promotions associated with the one or more users based at least partially on the target information.

10. The one or more computer storage media of claim 9, wherein the extraction component is configured to determine whether a first post of the one or more posts is associated with a first potential financial transaction of the one or more potential financial transactions, and wherein, on condition that the first post is associated with the first potential financial transaction, the target component generates the target information to include first target information associated with the first potential financial transaction.

11. The one or more computer storage media of claim 9 further comprising an account component configured to determine whether a first user of the one or more users is associated with a user account, wherein, on condition that the first user is associated with the user account, the target component uses account data associated with the user account to generate at least a portion of the target information.

12. The one or more computer storage media of claim 9 further comprising an account component configured to identify an opportunity to support the plurality of terms, and retrieve account data associated with the first user that supports the plurality of terms, wherein the target component uses the account data to generate at least a portion of the target information.

13. The one or more computer storage media of claim 9, wherein the target component is configured to identify the one or more promotion systems.

14. The one or more computer storage media of claim 9 further comprising a metric component configured to generate one or more confidence scores associated with the target information.

15. The one or more computer storage media of claim 14 further comprising a metric component configured to determine one or more weights associated with one or more reliabilities of the one or more confidence scores.

16. A computer-implemented method for generating one or more time-bound predictions to facilitate one or more financial transactions, the computer-implemented method comprising:
retrieving one or more social media posts associated with one or more users;
extracting a plurality of terms from a first post of the one or more social media posts, the first post associated with a first user of the one or more users;
analyzing the plurality of terms to determine whether the first post is associated with a potential financial transaction; and
on condition that the first post is associated with the potential financial transaction, using the plurality of terms to generate target information associated with the potential financial transaction, and transmitting the target information to one or more promotion systems such that the one or more promotion systems are configured to use the target information to generate one or more promotions associated with the first user.

17. The computer-implemented method of claim 16 further comprising:
identifying account data associated with the first user; and
identifying the one or more social media feeds based on the account data.

18. The computer-implemented method of claim 16 further comprising:
identifying an opportunity to support the plurality of terms; and
retrieving account data associated with the first user that supports the plurality of terms, wherein the account data is used to generate at least a portion of the target information.

19. The computer-implemented method of claim 16 further comprising using the plurality of terms to identify the one or more promotion systems.

20. The computer-implemented method of claim 16 further comprising generating one or more confidence scores associated with the target information.
